(19) United States
(12) Patent Application Publication
(10) Pub. No.: US 2009/0086300 A1
(43) Pub. Date: Apr. 2, 2009

(54) FEEDBACK DRIVE FOR RESONANT OSCILLATION OF SCANNER MECHANISM

(76) Inventor: Robert E. Blake, Woodbury Heights, NJ (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 11/862,884

(22) Filed: Sep. 27, 2007

(51) Int. Cl. G02B 26/08

(52) U.S. Cl. 359/199; 250/235

(57) ABSTRACT

A drive for oscillating a reflector in a beam scanner, and for other similar oscillating devices, forms a feedback loop synchronized to the natural resonance of a resiliently movable flipper strip carrying the reflector. A magnet on the free end of the flipper generates a current in a sensing coil coupled to an amplifier upon passage of the magnet. The triggering signal is phase delayed by one or more integrators or timers, whereupon a driving current is generated, for example in a different winding on the same spool as the sensing coil. The driving current is applied at a phase delay that maintains oscillation up to a high operational frequency in a range. Synchronizing the drive to the natural frequency and phase of the flipper substantially reduces power consumption compared to forcing oscillation to a different reference.

### FIELD OF THE INVENTION

The invention relates to driving electromechanical oscillating mechanisms. The position of a resiliently movable element in its oscillating cycle is sensed in a feedback loop that triggers drive pulses phased to maintain oscillation. The result is oscillation near the natural mechanical resonance of the device, at low power consumption. The technique is applied to driving a resilient flipper carrying a reflector used to scan the illuminating beam of a barcode reader.

### PRIOR ART

Electromechanical oscillating devices have various applications, one being to position a reflector or other movable part when repetitively scanning a point back and forth over an optical scan line. In one type of optical beam scanner that is useful for example in a barcode reader, a laser beam is incident on a reflector carried on a resilient film that is fixed along a line at one end, defining a resilient hinging axis. A magnet or coil on the substrate is spaced from the hinging axis and interacts with a fixed magnet or coil in an electromagnetic drive configuration.

An example of a scanning apparatus with an electromechanically oscillating reflector is disclosed in U.S. Pat. No. 6,227,450—Blake et al. In this apparatus, a magnet is carried on a flexibly resilient strip at a distance from an end of the strip that is fixed to a housing, forming a hinging end. The strip has a reflector on a surface where an illuminating beam is incident from a laser diode or the like. A coil on a fixed housing near the path of the magnet is driven with a current signal that produces a time varying magnetic field. This urges the strip to flex via force applied to the magnet. The strip is flexed to tilt the reflector back and forth, directing the beam to pass back and forth along a scan line, for example aimed by manipulating a hand held barcode reader.

Sinusoidal force may be applied in both directions to push and pull the reflector to tilt, and thereby to scan the beam. Alternatively, force can be applied in one direction with the resilience of the material providing a return force. The reflector moves in a periodic oscillating motion wherein the reflector is tilted repetitively to trace a scanning point back and forth over a scan line in a plane parallel to the hinging axis.

Such a scanning mechanism can resemble a pendulum and has a natural oscillation frequency determined by its length, resilient spring constant and other factors. The force applied to drive a pendulum or other oscillating mechanism can be applied as pulses that briefly accelerate the pendulum to maintain continuing oscillation.

Such a mirror can similarly be arranged to scan a reflected beam in two dimensions, by providing for relative displacement of the mounting for the scanning mirror in a direction orthogonal to the plane of oscillation of the mirror itself. In sheet scanners, laser printers and the like, a line scanning means is relatively displaced in a direction perpendicular to the scan line. A movable carriage or a movable sheet feed can accomplish such movement. A scanner can also be arranged to scan a field in a raster pattern by mounting a single mirror with two torsional hinges oriented orthogonally and arranged so that the mechanism of one hinge is carried so as to be tilted by the other hinge. A device capable of raster-like sweeps of the reflected beam in that way is disclosed in U.S. Patent Publication 2005/0078169 to Tumer

Another apparatus and method for adjusting the frequency of a scanning device is disclosed in U.S. Pat. No. 6,687,034 to Wine et al. (hereinafter “Wine”). Wine discloses a MEMS device which includes a flexible arm extending from an oscillatory body. The flexible arm is formed from a material which bends when an electrical field is applied to it; resulting in a shift of the moment of inertia of the oscillatory body and a secondary mass carried by the flexible arm. The shifted moment of inertia changes the resonant frequency of the MEMS device.

In some applications of scanners, it is important to oscillate the flipper or its drive circuits at specific frequency and perhaps with a specific phase relationship synchronous with other moving elements. Barcode readers typically do not require precision in frequency or a particular phase relationship with a movable conveyor or feeder. On the contrary, the uncertainty of the nature and position of the barcode to be scanned provide practical reasons to make barcode readers tolerant of timing variations. In the case of a linear barcode scanner, for example, the code to be read may be relatively nearer or farther from the scanner, and thus appears larger or smaller, producing a signal time span that may be longer or shorter at a given scan rate. The scan line over the barcode may not be quite perpendicular to the code bars, similarly making the bars apparently larger. Variations within a reasonable tolerance can be resolved in the reading electronics. Nevertheless, stable, highly-dependable and long-lived scanning of the beam is a key requirement of optical scanning systems such as barcode readers.

Scanners are frequently battery powered, such as hand-held barcode readers. Particularly in the case of battery powered portable devices, the scanning mirror mechanism and drive must be energy efficient. In the case of a driver for an oscillating movable device such as a flexible flipper for a mirror, the power level required to drive the device can vary depending on how the drive operates.

Portable scanning devices may be used in a variety of climates, especially at a range of ambient temperatures. The ambient temperature affects the stiffness of a flexible flipper and therefore the natural resonant frequency varies with temperature. It would be advantageous to provide a drive for a flipper that does not expend power unnecessarily, by driving a flipper at a frequency that they must remain low power when used in these various climates. But, a larger amount of power is necessary if the mechanical parts are forced to conform to the phase and frequency of a driver at an arbitrary frequency. A small amount of power might maintain continued oscillation if force is applied at the resonant frequency of the oscillating device and a push and/or pull force is applied at the a specific time (phase) in the period of oscillation.

At least for the foregoing reasons, challenges are presented to provide a mechanical oscillating body that has a predictable resonant frequency, an electronic oscillator and driver that can match the mechanical resonant frequency, and finally to operate the driver synch and in phase with oscillation of the mechanical body.

Depending on the apparatus that employs the scanning mechanism, it may be desirable to operate at a particular scanning frequency. Similarly, a particular phase relationship between the scanning and some synchronizing timing reference might be needed. The mechanism might be allowed to oscillate naturally, but changing conditions affect the natural oscillation frequency. For example, temperature changes, aging of the resilient material and similar conditions may affect the natural frequency. Alternatively, the mechanism might be forced to comply with a drive signal from an electronic oscillator that effectively dictates the oscillation frequency and phase.

If a specific amplitude, frequency and phase relationship could be maintained relative to the natural oscillation of the mechanism, oscillation may be driven indefinitely by applying just enough electromagnetic energy to keep the resilient part swinging naturally at a desired displacement amplitude. However, this is a challenge because the natural oscillation frequency varies somewhat from one device to another within normal manufacturing variations and tolerances. Even if care is paid to producing devices according to a tight standard of natural oscillation frequency, the natural frequency will change with time and temperature. Applying force at an inaccurate phase position can damp oscillation, render oscillation unstable or require more driving energy than might be necessary to sustain natural oscillation.

### SUMMARY

According to an aspect of the present disclosure, a flipper and flipper drive are arranged so that the natural mechanical motion of the resonant flipper provides the operational reference frequency. The relative phase position in time, at which and electromagnetic driver produces a driving pulse, is determined from the displacement of the oscillating member, and at a nominal frequency at least approximately equal to the natural frequency is made optimal for maintaining oscillation. As a result, oscillation is established and maintained continuously at or very near to the natural oscillation frequency, with a minimum expenditure of power. Push and/or pull forces are applied at a timing based on the position of the flipper as detected using a proximity feedback sensor.

In one embodiment, the oscillating apparatus comprises a housing, a flipper assembly and a controller. The flipper assembly includes a resiliently flexible member having an end fixed to the housing along a line defining a hinge axis. The flipper carries a reflective surface and has a magnetic element (either a permanent magnet or a driven coil), spaced from the fixed end, and positioned to intercept the field of a corresponding magnet or coil disposed on the housing. At least one of the magnetic elements comprises a coil to which a drive pulse is applied at least at one phase position in the periodic oscillation cycle of the resiliently flexible member of the flipper. In an exemplary embodiment, the flipper carries a permanent magnet and the driving coil is fixed relative to the housing.

The flexible member is subject to a range of movement relative to the housing, thereby tilting the reflective surface back and forth in relation to the housing. In this way, the device and be used to scan a laser beam repetitively over a line in a bar code reader or to scan a modulated beam in a laser printer. The device can be used with associated input optics to scan a moving point of a field of view. By mounting flippers with orthogonal axes upon one another, the device can be used to scan two dimensions, such as a raster patter. The controller includes a control circuit configured to output a drive pulse for controlling the movement of the flipper assembly. The drive pulse can provide a synchronizing signal for other elements of the apparatus as a whole.

A method for oscillating a reflective surface for use in an optical scanning device is also described herein. One method comprises the steps of mounting a reflective surface on a free end of a flexible member, mounting a magnet on the free end of the flexible member, providing a first coil a magnetically effective distance from the magnet and periodically providing a force on the magnet causing the flexible member to oscillating by adjusting the current in the first coil.

### BRIEF DESCRIPTION OF THE DRAWINGS

FIG. 1 illustrates a first exemplary embodiment of an oscillating system of the present invention.

FIG. 2 is a block diagram of the control assembly of the oscillating system of the present invention.

FIG. 3 is a schematic circuit diagram illustrating an exemplary practical execution of the apparatus shown in block diagram in FIG. 2.

### DETAILED DESCRIPTION

This description of the exemplary embodiments is intended to be read in connection with the accompanying drawings, which are to be considered part of the entire written description. In this description, certain relative terms are employed from time to time to describe relative positions or directions. Examples are “lower,” “upper,” “horizontal,” “vertical,”, “above,” “below,” etc. These terms are used to refer for convenience in referring to the orientations and relative positions in the examples as then described or as shown, and should not be construed to require that the apparatus be constructed or operated in any particular orientation. Terms concerning attachments, coupling and the like, such as “connected” and “interconnected,” are used herein to describe relationships wherein structures are secured or attached to one another either directly or indirectly through intervening structures, and should be construed to encompass either movable or rigid connections, attachments or relationships, unless expressly described otherwise.

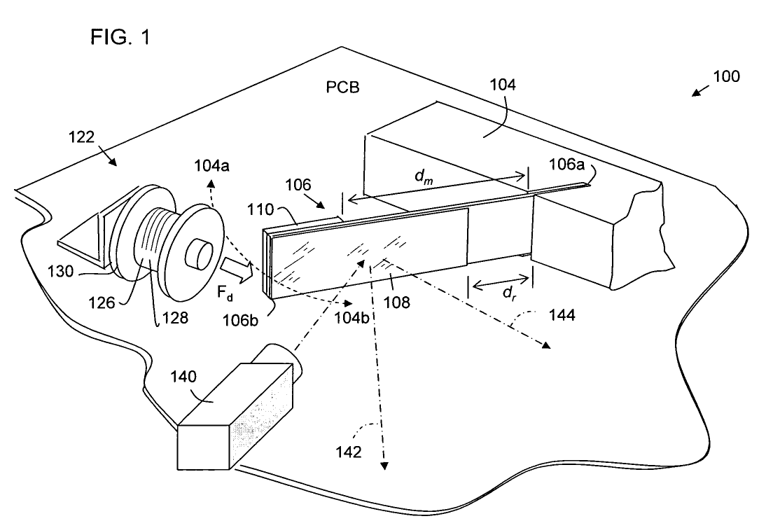

FIG. 1 illustrates an exemplary embodiment of an oscillating system 100. The oscillating system as shown includes a housing 104, a flipper assembly 102 coupled to the housing 104 and a control assembly 120. Flipper assembly 102 comprises a flexible member 106, a reflective surface 108 and a magnet 110.

The housing 104 functions as a support that fixes the relative positions of the respective parts including the flexible member 106 and its associated reflector, which is in the path of the laser or other light source, and the magnet 110 carried on the flexible member so as to pass in range of the drive coil 130. The housing can comprise any suitably rigid material providing support for the oscillating assembly 100. Housing 104 can be formed from a polymer, such as, for example, polystyrene, polyvinyl chloride (PVC), polyethylene or polycarbonate, and can be attached or mounted on the printed circuit board together with the circuit elements of the driving apparatus, including feedback circuitry 124, 128 as discussed below, and preferably also including the light receiving sensors, amplifiers and decoding elements of the scanner. The housing 104 provides a fixed support for an end of flexible member 106, such as a slot in which the end of the flexible member is received and glued or clamped. The other end of flexible member 106 swings or pivots freely, flexing and hinging around an axis defined by the edge of the slot or clamp at which flexible member 106 is attached to housing 104, moving between extremes 104a, 104b in FIG. 1, when flexible member 106 is oscillated for scanning. Housing 104 may be integrally molded of formed from a plurality of attached pieces. The housing 104 may be attached to the printed circuit board by adhesive, fasteners, a complementary snap fit or the like.

Flexible member 106 has a fixed end 106a and a free end 106b. Fixed end 106a of flexible member 106 is secured to housing 104. On one side of member 106, a foil or similar material functions as a light reflector 108. On the opposite side of member 106 from reflector 108 is a permanent magnet 110. Both the reflector 108 and the magnet 110 are spaced from the attachment of member 106 to housing 104, where member 106 is fixed. Thus flexing of member 106 results in tilting of the reflector 108 and displacement of the magnet 110.

Along at least a sufficient length to establish a zone of resilient flexing between the fixed end 106a and the proximal edge of the reflector 108, the flexible or flexing member 106 comprises a supporting portion of a resilient material. In this example, member 106 comprises resilient material along its length, but the distal or free end also could comprise a rigid material, provided that a resilient flexing web portion is provided along the more proximal part between the attachment to housing 104 and the reflector 108. This permits oscillation of member 106 through the arc show by line 104a-104b. The web portion of member 106 has a constant thickness and is substantially straight or planar at rest in the example shown. The web portion of member 106 alternatively could define a curve or fold. The web portion also could have a slot-like depression on one or both sides extending parallel to the surface of housing 104, or could have a relatively thickened rib parallel to the surface of housing 104, which in either case can define a preferential line of flexing on a hinge axis parallel to the edge of the slot in which member 106 is received in or attached to housing 104.

The flexible web portion (optionally extending the full length of member 106 as shown) may comprise any of various resilient and spring-like materials that can swing at a resonant frequency through arc 104a-104b. During this motion, the reflector 108 is tilted and the magnet 110 on member 106 is carried through a zone wherein the magnet 110 and certain drive and feedback coils 122, 126 are brought into sufficient proximity to interact as discussed below.

In one embodiment, the flexible member 106, or at least the flexing portion of member 106 that is adjacent to the attachment with housing 104, comprises a durable polyimide films, such as the Kapton brand polyimide available from DuPont Electronics. This material has a superior combination of durability and flexible resonance at a reasonably stable and repeatable oscillation frequency when incorporated in a scanning optical device such as a handheld barcode scanner.

The flexible member 106 may comprise a single integral thickness or strip of Kapton polyimide or the like, or alternatively may comprises a laminate of two or more flexible polyimide or other polymer layers, or a laminate comprising other materials such as ferrous spring steel that can function as the magnet, or nonferrous spring materials such as brass. In any event, the structure of member 106 is structured and mounted so as to flex and resonate during scanning.

The material characteristics, thickness, potential laminated character, length and similar characteristics of flexible member 106 affect the resonant frequency and the reasonable range of motion between extremes 104a, 104b. In one embodiment, a flexible member 106 is formed by laminating a Kapton polyimide film layer in a sandwich between two pieces of thin copper. The copper is etched by techniques known in the art to provide a flexible member 106 with the desired resonant frequency. An operable thickness of flexible member 106 is approximately 0.5 mm to 3 mm and more preferably 1 mm to 3 mm depending upon the desired resonant frequency of the flipper assembly 102. The additional of the copper strips adds rigidity to the KAPTON® polyimide film to obtain the desired range of motion and resonant frequency. Copper is nonferrous, and the electromagnetic drive in this embodiment is facilitated by attachment of a magnet 110 as mentioned above.

The reflective surface 108 that is coupled to the flexible member 106 of the flipper assembly 102 is caused to tilt during oscillation and thereby redirects a reflected beam back and forth over a scanning arc between extremes 142, 144. In this embodiment, reflective surface 108 is disposed on the distal or free end 106b of flexible member 106, extending from a spacing distance dᵣ from the housing 104 to the extreme end 106b. The spacing by distance dᵣ from housing 104 is such that the reflector does not interfere with the oscillatory motion of flexible member 106. The range of motion is not restricted by stiffness in the zone of flexing (within distance dr) contributed by the reflector. Also oscillation of member 106 of the flipper assembly 102 does not tend to curve the surface of the reflector 108 substantially, which might produce lens effects. The length along distance dr in which the member 106 is free to flex can be made relatively shorter to reduce the displacement span during oscillation and increase the frequency of natural oscillation by making the member 106 more stiff. Or, vice versa, increasing the length dr or providing a generally longer oscillating member, like a pendulum, lowers the natural frequency and increases the span of displacement.

The reflective surface 108 may be provided by attaching a reflective foil, affixing a silvered piece of glass or otherwise rendering a portion of the member 106 reflective on the side and over the area in which a beam from the light source 140, such as a laser diode, will be incident. The reflective element can be affixed adhesively or bonded to the surface of member 106, or incorporated as a layer of a laminate below the surface.

Provided that the beam from the light source is incident on the reflector 108 as the member 106 tilts in one direction and the other during oscillation, the reflection of the beam will pass through a scanning arc, such as between extremes 142, 144, causing the beam to trace a line along an planar surface (not shown) in the field of view. Depending on precisely how the oscillating system is incorporated into an optical scanning device (e.g., handheld, fixedly mounted, near to the target or far), the light source 140 may be positioned to emit light directly at reflective surface 108, and one or both of the light source 140 and the image reflected from the targeted object may be positioned to reflect at one or more additional reflective surfaces (not shown) that fold the light path. It may also be appropriate in some embodiments to use lenses or transparent windows and covers. These specifics are not critical to operation and have not been shown in the drawing.

Light source 140 may comprise a coherent light source, such as a laser diode or micro-laser, which is advantageous for producing a bright and minimally divergent beam for illumination. The reflection of the beam from the target is divergent in any case and the reflected light can be captured using a lens. Non-coherent light sources such as plural light emitting diodes or the like can also be employed. The light source 140 may be continuously operated or activated and deactivated as needed. The light source 140 can include directly modulated light emitters such as light emitting diodes (LEDs) or may include continuous light emitters that are indirectly modulated such as acousto-optic modulators.

FIG. 1 illustrates an exemplary light sweep denoted by dashed lines 142 and 144. It will appreciated that the length of the light sweep may be increased or decreased as desired by suitable arrangement of the optical source, reflector, oscillation displacement and target position.

In a preferred arrangement, a flat mirror or foil reflector is mounted on a Kapton polyimide strip to form the movable part, sometimes termed the “flipper.” This resilient material is durable, resiliently flexible and capable of many flexing repetitions when clamped stationary at one end and free to hinge back and forth at the free end.

An electromagnetically powered drive applies the periodic signal that applies a force to push or pull flipper along at least during a limited part of its cycle to flex repetitively and continuously notwithstanding frictional losses that would eventually damp oscillation to zero in the absence of a drive. Although it is possible to mount an electromagnetic coil on the flipper, e.g., embedding or laminating conductors and making drive connections at an edge of member 106, it is generally more convenient to place a permanent magnet or ferrous element on the flipper at a distance from the fixed mounting of element 106. Oscillation is driven by applying a current signal at least during a pulse interval in the cycle of oscillation, via a coil is placed near the path of the magnet as shown in FIG. 1.

A sinusoidal signal could be applied to the oscillation drive coil. However according to an aspect of the invention, a pulsed current is applied and the phase timing or position at which the drive pulse is applied in the oscillation cycle is timed specifically by detecting the passage of the member 106 through a point of proximity with a position sensor. Preferably, the same coil spool used for driving oscillation carries windings coupled to an amplifier that produces a detection signal.

The member 106 is urged to continue to oscillate by applying a pulsed force at a given phase position in the period of oscillation. However applying a momentary force in this way does not substantially determine the oscillation frequency and instead simply adds an impetus to keep member 106 moving. The member 106 actually oscillates at its natural oscillation frequency. The phase position at which the pulse is applied can be, for example, after the change of direction passing though an extreme of displacement. This action is not unlike pushing a child on a playground swing after swing passes through the rear extreme and is moving forward. Provided that the force is applied momentarily and at a point in the forward arc, the force advances the swing without altering the frequency of oscillation, and without retarding the natural oscillation in any way.

The drive coil employed according to this embodiment can be mounted in a manner similar to that disclosed, for example, in U.S. Pat. No. 6,227,450—Blake et al., which is hereby fully incorporated in this disclosure, and used to apply at least one electromagnetic drive impetus at least at one phase interval in the oscillation cycle. The invention is not limited to a magnetic drive, however, and could also be embodied in other powered configurations, such as a piezoelectric drive or the like, wherein a momentary force can be applied by electrical, mechanical, fluid pressure or another form of pulsed force application.

The flipper resembles a pendulum structure except the rest position is determined by the rest position of the resilient material rather than orientation relative to gravity. A characteristic resonance is determined by the resilience of the hinge, the stiffness, length and mass distribution along the of flipper, etc. The specific resonant frequency may change over time, for example with age and use, and with temperature fluctuation. The actual oscillation frequency also is influenced by the nature and periodic frequency of the signal driving the flipper.

Referring again to FIG. 1, magnet 110 is disposed on the free end 106b of flexible member 106 and is subjected to a momentary magnetic force at a timed point in the oscillation period of the flipper. In one embodiment, flexible member 106 is sandwiched between reflective surface 108 and magnet 110. The magnet 110 is disposed on the side of the flexible member 106 away from the light source 140 so as to provide a wide unobstructed reflector area. The magnet is spaced from the fixed end of member 106 attached to housing 104, and in this case is at the extreme distal end of member 106. Other specific arrangements for magnet 110 are possible. For example, magnet 110 may be disposed on the free end 106a of flexible member 106 between flexible member 106 and the reflective surface 108. The magnet can be provided by incorporating a ferrous metal such as a ferrous oxide material in the plastic or in a laminate layer of member 106.

In the embodiment shown, the magnet 110 comprises a discrete permanent magnet spaced from the fixed end 106a of flexible member 106 by a distance dm so that the magnet does not interfere with the ability of the flexible member 106 to move in relation to the housing 104, and is located at a position where the magnet can readily interact with the drive coils 122. Similar to variations respecting the distance dr over which the member 106 flexes, the distance dm may be varied in a manner that affects the oscillation of the flipper assembly 102, e.g., by providing a longer or shorter effective pendulum length by changing the weight distribution.

Magnet 110 may comprise various magnetic materials such as ferrite, neodymium, samarium-cobalt, etc. In a preferred arrangement, magnet 110 comprises neodymium, which is inexpensive and has a good ratio of mass to magnetic permeability. It is possible to provide one magnet or more than one magnet; however the size and weight of magnet 110 should be limited so as not to impede or require a great deal of energy to achieve and steadily drive oscillation of flexible member 106 and the desired periodic tilting action of reflector 108 thereon.

The magnet 110 provides a static magnetic force in an attractive or repelling direction that interacts with the magnetic field generated by current in drive coil 122. This magnetic field is designated in FIG. 1 as force F_{d}, and is directed along the axis of coil on magnet 110, which roughly corresponds to a direction tangential to the arc of the permanent magnet 110 on member 106. This magnetic force F_{d} exerted by drive coil 122 urges the magnet 110 by an incremental amount in a direction that advances oscillation.

According to an aspect of the invention, the drive signal (force F_{d}) is applied at a phase position the oscillation of member 106 that is related to the position of member 106, which is sensed using a sensing arrangement that preferably comprises a winding on the same coil structure used for drive coil 122. The position of the flipper member 106 results from oscillation, and oscillation occurs at a frequency affected by the material characteristics of the member 106 and the physical characteristics of the member 106 and its attachments, especially the distribution of weight along the length of member 106. The application of the drive signal is timed and triggered to apply force at a predetermined delay interval after proximity of the member 106 is sensed in a feedback coil 126. Thus the drive pulse dependably applies force in a direction that contributes toward continued oscillation but does not control the oscillation frequency. This allows the drive to accommodate the natural oscillation frequency of member 106, and substantially reduces the power needed to drive oscillation of the flipper.

The drive pulse width is timed to apply force for an interval that would be an optimal pulse width for a frequency that is slightly higher than the expected natural oscillation frequency of member 106. That is, the drive pulses typically somewhat narrower than the pulse might be to drive oscillation at a nominal expected natural frequency. However the drive pulses can contribute toward continuing oscillation anywhere in a range of actual frequencies. For example, assuming that a natural oscillation frequency of about 220 scans per second is nominal, the drive pulses are applied at a pulse width and optimal timing for an actual frequency of about 10 Hz above the expected operating frequency. The drive pulses are applied at a phase delay following sensing of the permanent magnet. The drive pulses contribute to oscillation at the natural oscillation frequency.

The exemplary oscillating system 100 illustrated in FIG. 1 also includes a control assembly 120 which includes a drive coil 122, control circuitry 124, a feedback coil 126 and feedback circuitry 128. In a preferred embodiment and referring to FIG. 1, drive coil 122 and feedback coil 126 are wound on the same bobbin 130. However, drive coil 122 and feedback coil 126 alternatively could be physically separated, e.g., disposed on their own bobbins. In the embodiment wherein the drive coil 122 and feedback sensing coil 126 are on the same axis, the two coils are coupled electromagnetically. However a timing arrangement in the feedback sensing and drive signal path includes a timer that defines certain minimum timing constraints. This prevents magnetic coupling from the drive coil to the feedback sensing coil from becoming the feedback signal to which the drive oscillator response. The drive oscillator employs the resonance of the flipper as a basis from control of the oscillation frequency, rather than forcing the flipper to move at a frequency that is independent of the natural physical resonance of the flipper. Drive coil 122 is positioned adjacent to the path of the passing permanent magnet 110, within a distance that allows the current in the drive coil to contribute effectively to maintaining oscillation. The oscillation proceeds at the natural resonant frequency.

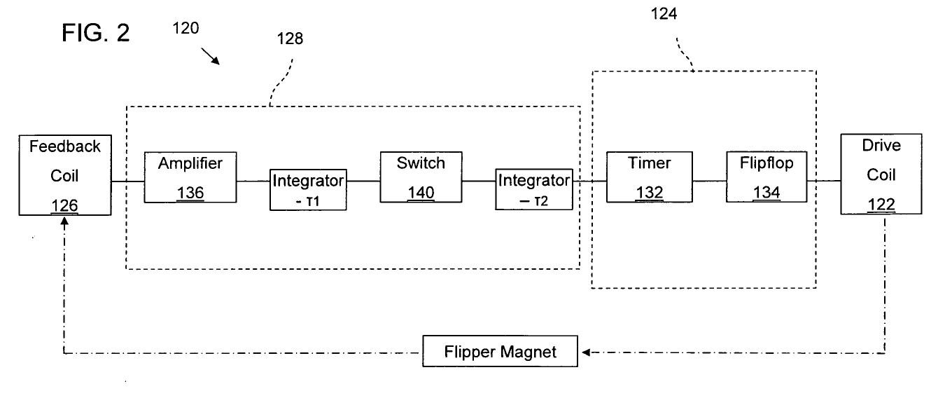

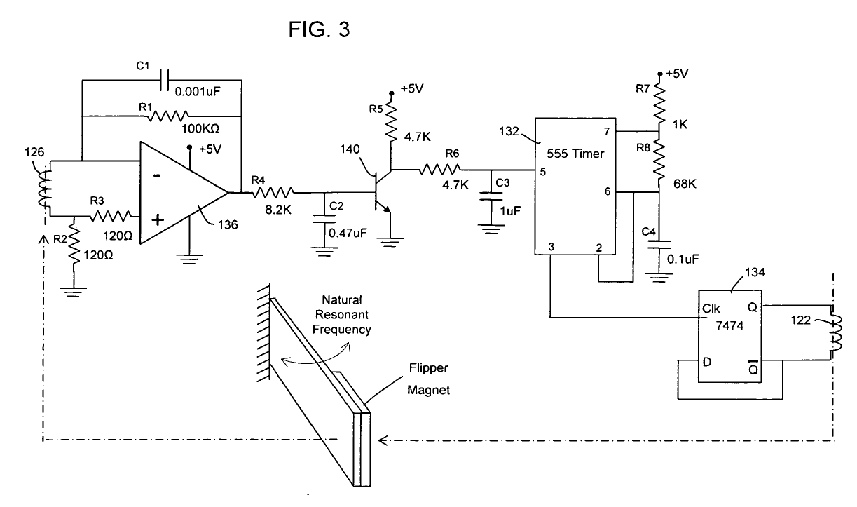

FIG. 2 illustrates a block diagram of control assembly 120 showing how the natural oscillation of the flipper substantially determines the operational frequency of the drive circuit in a feedback arrangement. A practical circuit for embodying the control is shown in FIG. 3. Referring to FIG. 2, a control assembly 120 has a driving section 124 that applies a driving signal to move the flipper by coupling current to the drive coil 122, responsive to a feedback sensing 128 that provides a signal to trigger the timer 132 and a flipflop 134 of the drive section 124. The timer 134 is triggered in response to a signal generated by amplifying the current in a feedback coil 126 wherein current is induced by the relative movement of magnet 110 carried on the flipper member 106. In particular, the magnet 110 induces a current in the feedback coil 126 when moving into proximity with the coil 126. The coil current is amplified, for example by an operational amplifier 136. The output is coupled through an integrator section to a switching transistor and from the switching transistor through a second integrator to trigger the timer.

The two integrators contribute delay according to RC time constants. The timer is operated as a monostable multivibrator and the timed pulse width of the timer defines a maximum frequency above which the oscillator cannot operate. Preferably, the maximum frequency as determined by the integrators and the timed interval of the timer pulse are chosen to provide a maximum operational frequency that is just slightly higher than the highest natural oscillation frequency that might be expected due to aging of the flipper, temperature changes, etc. In one embodiment, the natural resonant flipper frequency is expected to be about 25/40 Hz and the timing arrangements are such as to time out at each delay point (the integrators and the timer 132) so as to permit operation at a frequency up to 10 Hz higher than the expected range.

In the circuit shown in FIG. 3, the input to amplifier 136 is substantially provided by the time varying induced current in sensing coil 126, which arises when the flipper magnet comes into close approach to the coil 126. The gain of amplifier 136 is determined by the ratio of resistors R1 and R2. Resistor R3 decouples the coil current at one amplifier input. A capacitor C1 is charged during quiescence to the voltage difference between the amplifier output and the noninverting input.

When a current is induced in coil 126 by the moving magnet in proximity with coil 126, the amplifier output changes state. Series resistor R4 and parallel capacitor C2 define an integrator that inserts a time delay during which capacitor C2 is charged or discharged through resistor R4. When capacitor C2 is charged to the threshold voltage for switching transistor 140, the transistor 140 conducts in saturation, providing a voltage drop through resistor R5 and discharging the capacitor C3 through resistor R6 of a second integrator defined by C3 and R6.

A transition at the input to timer 132 produces an output pulse of a duration determined by the time constants of resistors R7, R8 and capacitor C4. The pulse from the timer 132 is used as the clock input to a D type flipflop 134. The not-Q output of flipflop 134 is coupled to the D input, so that the flipflop toggles with each transition of the timer. The Q and not-Q outputs of the flipflop 134 are used as push-pull outputs coupled to opposite terminals of the drive coil 122. (It would also be possible to provide a push-pull transistor arrangement, not shown, to provide for higher current operation switched by flipflop 134.)

As a result of this circuit, every second time that the permanent magnet 110 of the flipper 106 approaches and passes coil 126 (in one direction or the other), the output drive coil 122 is powered commencing after a delay defined by the cascaded integrators R4/C2 and R6/C3, plus the timed period of timer 132. As a practical matter, the drive circuit provides a pulse that urges the flipper 106 to continue oscillating by contributing an incremental nudge in a forward direction. This nudge is timed based on the sensed position of the flipper, and thus the flipper resonant frequency is the parameter that controls the frequency of oscillation maintained by the drive circuit.

In comparison to operation at an arbitrary frequency and phase, the disclosed arrangement operates at a frequency determined by the resonance of the flipper and applies a drive pulse at a phase position in the period of oscillation that is determined by the position of the flipper. In this condition, there is a minimum amount of energy wasted and the energy applied to the coil is used to cooperate with the natural period of oscillation.

Variations in temperature, wear and aging of the flipper at its area of flexing and similar factors may alter the frequency at which the flipper is naturally resonant. The disclosed circuit will remain responsive to the natural frequency of the flipper as the resonant frequency changes, provided that the timer and integrator time constants are consistent with the changing frequency. This can be arranged by providing a timer pulse and integrator time constants that are short enough to permit operation slightly above the maximum frequency that is likely to be encountered under any conditions.

The invention has been described and demonstrated in connection with general and specific practical examples. It should be appreciated that the invention is not limited to the embodiments disclosed as examples. Reference should be made to the appended claims rather than the illustrative examples in order to determine the scope of the invention in which exclusive rights are claimed.

What is claimed is:

1. A scanning beam apparatus, comprising:
an oscillating member carrying a reflector, the oscillating member being movable resiliently relative to a housing for redirecting a beam, the oscillating member having a resonant frequency and the reflector directing the beam repetitively over a scanning path during oscillation;
a driver operable to apply a force to the oscillating member momentarily in at least one direction to advance movement of the oscillating member for maintaining continued oscillation;
a sensor coupled to detect presence of the oscillating member at least at one phase position in said period;
wherein the driver is triggered to apply said force at a time determined by detection of said presence of the oscillating member by the sensor;
whereby the oscillating drive apparatus maintains said oscillation at the resonant frequency of the oscillating member.

2. The scanning beam apparatus of claim 1, further comprising a time delay generator comprising at least one of a timer and an integrator circuit, coupled between the sensor and the driver, wherein the time delay generator introduces a phase delay between said detection of said presence of the oscillating member by the sensor and application of said force by the driver.

3. The scanning beam apparatus of claim 2, wherein the phase delay encompasses a time period defining a highest resonant frequency in a range of resonant frequencies at which the scanning beam apparatus is operable.

4. The scanning beam apparatus of claim 1, wherein the oscillating member comprising a resiliently flexible film attached at one end to the housing, and wherein the driver comprises a drive coil and at least one of a permanent magnet and a second coil, respectively fixed relative to the housing and attached to the oscillating member.

5. The scanning beam apparatus of claim 4, wherein the flexible film comprises at least one layer of a polyimide film.

6. The scanning beam apparatus of claim 4, wherein the driver comprises a magnet attached to the flexible film at a point spaced from the end attached to the housing, and the reflector comprises a reflective surface of the film.

7. The scanning beam apparatus of claim 4, wherein the driver comprises a magnet attached to the flexible film at a point spaced from the end attached to the housing, and a coil fixed relative to the housing adjacent to a path of the magnet during movement of the oscillating member.

8. The scanning beam apparatus of claim 7, wherein the sensor comprises a coil fixed relative to the housing adjacent to the path of the magnet, and further comprising an amplifier coupled to the coil and a time delay generator coupled between an output of the amplifier and the driver, wherein the time delay generator produces a phase delay between detection of the oscillating member at the phase position by the sensor and application of the force by the driver.

9. The scanning beam apparatus of claim 8, wherein the coil of the driver and the coil coupled to the amplifier comprise different windings on a same coil structure.

10. The scanning beam apparatus of claim 1, further comprising a light source providing a beam directed onto the reflector.

11. An oscillating drive apparatus, comprising:
an oscillating member that is movable relative to the housing, the oscillating member having a resonant frequency and a period;
a driver operable to apply a force to the oscillating member in at least one direction to advance movement of the oscillating member during oscillation;
a sensor coupled to detect presence of the oscillating member at least at one phase position in said period;
wherein the driver is triggered to apply said force at a time determined by detection of said presence of the oscillating member by the sensor;
whereby the oscillating drive apparatus maintains oscillation at the resonant frequency of the oscillating member.

12. A method for oscillating a reflective surface for scanning an optical beam, comprising the steps of:
providing a reflective surface on a flexible member mounted to a fixed housing at one end and having a freely movable portion spaced from said end, and mounting a magnet on the freely movable portion, wherein the flexible member is subject to resilient deflection over an oscillation path and has a natural resonant frequency;
providing a sensing coil and a driving coil, and placing each of said coils in position to be magnetically coupled to the magnet during at least certain phase positions of the flexible member in the oscillation path;
periodically applying electromagnetic force against the magnet so as to drive the flexible member to oscillate by providing a current in the driving coil;
sensing a position of the magnet using the sensing coil; and,
timing the application of the electromagnetic force against the magnet as a function of a time at which the position of the magnet is sensed using the sensing coil;
and thereby maintaining oscillation at the natural resonant frequency.

13. The method of claim 12, wherein the timing of the application of the electromagnetic force comprises inserting a delay determined by at least one resistor-capacitor time constant.

14. The method of claim 13, wherein the time constant is substantially equal to a predetermined phase delay at a maximum operational frequency in a range.

15. The method of claim 12, wherein the sensing coil and the driving coil are windings on a same magnetic axis and further comprising introducing a predetermined delay between sensing the position of the magnet and applying the magnetic force.

16. The method of claim 15, wherein the predetermined delay is determined at least partly by a pulse width of a monostable timer.

17. The method of claim 15, wherein the predetermined delay is determined at least partly by a time constant of an integrator circuit.

18. The method of claim 12, further comprising operating the sensing coil to trigger application of current to the driving coil in a feedback loop, wherein the feedback loop is controlled by detection of the position of the magnet by the sensing coil to operate synchronously with the natural resonant frequency of the flexible member.

19. The method of claim 18, further comprising delaying the application of the electromagnetic force against the magnet by after sensing the position of the magnet by the sensing coil, for a phase interval sufficient to apply the force at a predetermined optimal phase position in the period.

20. The method of claim 19, wherein the predetermined optimal phase position in the period is selected for a natural resonant frequency near a maximum frequency in an operational range.
